(19) United States
(12) Patent Application Publication
(10) Pub. No.: US 2026/0342893 A1
(43) Pub. Date: Oct. 29, 2026

(54) SYSTEM AND METHOD PERFORMED THEREIN FOR HANDLING ONE OR MORE PACKETS IN A COMPUTER ENVIRONMENT

(71) Applicant: Telefonaktiebolaget LM Ericsson (publ), Stockholm (SE)

(72) Inventors: Amir ROOZBEH, STOCKHOLM (SE); Alireza FARSHIN, STOCKHOLM (SE); Marco CHIESA, SOLLENTUNA (SE); Martin JULIEN, MONTREAL, Québec (CA)

(21) Appl. No.: 19/486,471

(22) PCT Filed: May 31, 2023
(86) PCT No.: PCT/SE2023/050538

§ 371 Date: Nov. 21, 2025

(51) Int. Cl. H04L 69/22; H04L 43/08

(52) U.S. Cl. CPC H04L 69/22; H04L 43/08

(57) ABSTRACT

Embodiments herein relate to a method performed by a system (100) for handling one or more packets of an application or a service in a computer environment, wherein the system comprises a first entity (10) and a second entity (11). The system generates, at the first entity (10), a header of a packet, and sends, from the first entity (10), the header to the second entity (11). The system further adds, at the second entity (11), a payload to the header forming a packet; and transmits the packet towards a receiver node (12).

### TECHNICAL FIELD

Embodiments herein relate to a system and a method performed therein.

Furthermore, a computer program product and a computer-readable storage medium are also provided herein. In particular, embodiments herein relate to handling one or more packets of an application or a service in a computer environment.

### BACKGROUND

Network testing is integral to research and development (R&D) for every networking company, e.g., telecommunication companies, cloud providers & data center companies, and network equipment providers. These companies use testing equipment to (i) measure the performance, e.g., throughput and latency, and troubleshoot the existing infrastructure and (ii) benchmark the prototypes, or proof-of-concept solutions, for future generations of network equipment and protocols. Given the continuous increase in the network bandwidth, network testing equipment should support high-speed traffic generation at terabit-per-second rates while providing enough flexibility to be constantly adapted based on ongoing R&D needs, e.g., to support newer or up-to-date protocols. However, high-performance network testing equipment, aka network testers, is typically expensive, power-hungry, and insufficiently flexible for state-of-the-art R&D, especially at high rates. Moreover, state-of-the-art networking applications typically rely on connection-oriented & stateful transport protocols and demand detailed & fine-grained statistics, e.g., measuring tail latencies to mitigate service-level objective (SLO) violations, which requires supporting stateful network testing. For instance, many Internet services, such as video streaming applications and web servers, rely on TCP protocol to exchange messages, and cloud providers must guarantee/meet 99th percentile latency SLOs. Consequently, many commodity network testers are deployed on commodity CPU-based solutions to benefit from the flexibility of software solutions, and up-to-date network protocol stack, and abundant available memory to store detailed per-packet, or per-flow, statistics. However, commodity CPU-based solutions have a low performance-cost ratio and high-power consumption at very high rates.

### Common Networking Testing Scenarios.

Some common network testing scenarios are as follows:
Ensuring optimal performance: Network developers constantly introduce new features and optimize the code of networking applications, which makes it necessary to frequently test networking applications to ensure they are capable of achieving optimal throughput & latency.
Debugging/troubleshooting new devices or applications: In addition to optimal performance, it is important to guarantee the proper behavior for network devices and application. Therefore, network developers continuously use network testers during the R&D phase to develop, debug, and troubleshoot existing and new networking applications and devices. It is worth highlighting that some of the abnormal behaviors can only be identified at high-speed testing, making high-speed testing desirable.

The above scenarios could be applied to any networking application or device. Some examples are as follows:
Networking hardware/devices, such as: switches, routers, and middleboxes performing different network functions such as Firewall, DPI, NAPT, and core functionalities related to radio networks, e.g., 4G, LTE, 5G, and 6G.
Networking applications, such as: Web servers, key-value stores, video/audio streaming, monitoring, and virtualized telecommunication applications, e.g., in 5G or upcoming 6G.
   Stateless Vs. Stateful & Open-Loop Vs. Closed-Loop Networking Testing

Networking testers can be commonly split into two groups: open-loop and closed-loop testers.

Open-loop testers generate the testing traffic without receiving any feedback from the receivers (or to-be-tested servers, devices, or applications). They are typically capable of generating packets at higher rates, as the traffic generation is not affected by the network or the receiving application status. However, these testers are usually used to stress test the applications, which may be beyond the normal working conditions. These testers cannot be used to verify performance-based closed-loop properties. For instance, verifying the performance of the implementation of a congestion control mechanism requires to keep state also on the traffic generate to be able to generate the correct packets.

Closed-loop testers generate the testing traffic in accordance with some feedback from the network or the receivers (or to-be-tested servers, devices, or applications). For instance, a closed-loop tester could limit the number of in-flight packets or apply certain policies to consider the network behavior (e.g., packet drops) to automatically adjust the traffic generation rate.

In addition to open-loop and closed-loop testing, network testers could also be stateless and stateful. Like other networking contexts, stateful variants need to store & manage per-packet or per-flow data, which requires a lot of memory space and often additional processing, whereas stateless variants have simpler implementations and do not require per-packet or per-flow data stores. For instance, any networking application relying on stateful protocols (e.g., TCP) or requiring advanced or fine-grained statistics should use a stateful network tester.

### Network Testing Solutions

State-of-the-art network testing solutions can be split into three main categories: (i) commodity hardware solutions, (ii) specialized hardware solutions, and (iii) software solutions. Error! Reference source not found.

Commodity hardware testers. These solutions are typically offered by companies such as IXIA/Keysight and Xena Networks, and they can generate and capture packets at very high rates. Additionally, they are shipped with a bundle of proprietary tools (e.g., dashboards with user-friendly interface) and support packages, which facilitates network testing. However, these solutions are usually very expensive and less flexible due to their proprietary nature, which makes it harder for the R&D teams to test, benchmark, and troubleshoot next-generation products with the same hardware. For instance, a dual-100 Gbps-port packet generation module could cost over $100,000, which may need to be replaced within a few years, especially due to high-pace increases in the capability of high-speed networking equipment; in less than a decade, the commodity network device bandwidth has tremendously increased from 10/40 Gbps to 100/200 Gbps.

Specialized hardware testers. These solutions are based on programmable hardware, such as field-programmable gate arrays (FPGA) and programmable switches, and they typically use open-source software. FPGA solutions offer much more flexibility than the previous category, but they demand expert hardware designers to modify the existing solutions and/or introduce new functionalities into network testers. Additionally, FPGA-based solutions capable of capturing and generating packets at a very high rate also suffer from a low performance-cost ratio. There is a work, called HyperTester, which exploits the capabilities of programmable, application-specific integrated circuit (ASIC)—based, switches to implement an open-loop stateless network tester; however, it is not capable of testing stateful applications and providing fine-grained statistics about the performance due to the limitations of these programmable switches.

Software solutions. Software solutions are typically based on open-source software, e.g., TRex, MoonGen, and Click, and x86 CPU-based servers, which makes them extremely easy and fast to modify and update. Additionally, software solutions can easily test stateful networking applications and provide fine-grained statistics, since they have up-to-date network protocol stack and abundant memory to store per-flow & per-packet statistics. A single powerful server is often capable of generating and capturing packets up to −100 Gbps; however, shifting toward faster rates requires upgrading and scaling up the existing testbed, which increases the power consumption and the cost of the network tester. Software solutions become even more expensive when testing a small cluster in a datacenter, e.g., a load balancing mechanism. For example, a small rack with 32 servers would require 32 additional servers to generate traffic.

### Programmable Network Accelerators/Equipment.

Since CPU-based commodity hardware was not explicitly designed for packet processing, the recent increase in link speeds (e.g., 100/200/400 Gbps) has caused performance issues for networking applications deployed on top of commodity hardware. To alleviate performance issues, many network providers have started to introduce accelerators to facilitate packet processing at high rates. The common accelerators for packet processing are (i) smart/programmable network interface cards (NIC) and (ii) programmable switches.

### Smart/Programmable NICs.

Smart NICs provide either Advanced RISC Machines (ARM) cores or on-board FPGA to perform arbitrary processing on the incoming traffic within the NIC, before transferring the traffic to the host. While sounding appealing, benefiting from these offloading resources requires addressing many challenges, e.g., finding the trade-off between cost, flexibility, and performance.

For instance, in the case of Smart NICs equipped with low-frequency ARM cores and ASIC-based packet processors, it is essential to achieve optimal resource allocation while addressing the performance limitations, e.g., communication overhead imposed by peripheral component interconnect express (PCIe), to make the most out of offloading capabilities, i.e., offloading the right amount of stateless & costly operations to ARM cores & ASIC on the NIC vs. keeping the stateful & complex operations on powerful X86 cores on the host. Additionally, both offloaded sections, i.e., running on the smart NIC, and non-offloaded sections, i.e., running on the X86 CPU, should be optimized to achieve the maximum performance from the hardware.

FPGA-based NICs provide more flexibility and programmability, but they require skilled hardware architects with more expertise to implement high-performance and resource-efficient arbitrary logic for packet processing.

### Multi-Pipeline Switch Architecture.

High-speed network switches rely on silicon ASICs to achieve high throughput and low packet processing latencies. Switches can be divided into a data plane and control plane. The data plane is responsible for forwarding packets between the ports of the switch based on the packet processing logic. The control plane is responsible for configuring/populating some of the data plane match/action data structures, e.g., a Layer 2 forwarding table. FIG. 1 shows a simplified switch architecture. In data plane, the switch's silicon chips contain two main types of entities: Packet Processing Pipelines and a Traffic Manager.

A packet processing pipeline takes as input a sequence of packets from the input ports and transforms them according to the packet processing logic implemented by the pipeline, including identifying the outgoing port interface of the switch for the incoming traffic. More specifically, a pipeline consists of a Parser Module that extracts the headers from the packet; a Logic Module that performs a sequence of packet modification operations, implemented for instance using match-action tables; and a Deparser Module that emits the packet in output.

Each physical port interface on the switch is connected to exactly one of the packet processing pipelines. For example, on a 25.6-Tbps switch with 64 ports, there are four pipelines, each connected to 16 different port interfaces of the switch. There are two types of pipelines: Ingress and Egress. The Ingress pipeline processes packets received from the physical port interfaces, whereas the Egress pipeline processes packets leaving the switch through any ports connected to that pipeline. All the Ingress and Egress pipelines are interconnected via the Traffic Manager. The role of the Traffic Manager module is to forward packets from an Ingress pipeline to the correct Egress pipeline. The Traffic Manager also provides functionalities such as scheduling policies and beyond. It is also possible to (i) create loops and send back packets to an Ingress pipeline and (ii) multicast packets to multiple pipelines—not shown in the figure for brevity. Programmable and custom-built packet processing pipelines.

A packet processing pipeline contains different entities such as ternary content-addressable memory (TCAM) and/or Static random-access memory (SRAM), Arithmetic Logic Units (ALUs), Stateful ALUs (SALUs), and more. These resources are used to realize the desired packet processing logic. The packet processing logic typically consists of match/action tables where actions can be header rewriting, arithmetic operations, hash computation, and more. The specific entries contained in a table can be modified at run-time from the control-plane of the switch, e.g., adding a new rule matching traffic towards a specific IP subnet.

Differences exist between custom-built and programmable silicon chips. Custom-built chips support limited reconfiguration of the packet processing pipeline, e.g., defining the size of the different L2 and link power management (LPM) tables, where most of the logic is hardcoded in the silicon and cannot be modified. Programmable switches, instead, support expressive reconfigurations of the packet processing pipeline that can be used to completely modify the packet processing parsers and logic. Different languages can be used to express packet processing logic, including Programming Protocol-independent Packet Processors (P4) and network programming language (NPL). Each vendor provides a compiler to transform the packet processing program into the ASIC-specific configuration.

### SUMMARY

As part of developing embodiments herein one or more problems have been identified.
State-of-the-art network solutions construct packets in a monolithic way, where different parts of the packet, e.g., the packet header and payload, are constructed on the same device in the network.
State-of-the-art network solutions do not utilize the network resources efficiently to construct packets.
State-of-the-art stateful network solutions are primarily deployed on CPU-based hardware, which are power hungry and expensive.
State-of-the-art network testing solutions are expensive and power hungry.
State-of-the-art network testing solutions do not provide enough flexibility and do not exploit the new capabilities offered by the programmable network equipment.
State-of-the-art network testing solutions are primarily relying on software deployed on top of CPU-based hardware to generate the testing traffic.
State-of-the-art network testing solutions generate the entire traffic at the source, often with dummy payloads, which unnecessarily waste the available bandwidth and resources in the network.
State-of-the-art network solutions are not capable of performing stateful networking testing using programmable switches.
State-of-the-art network testing solutions are running in a logically centralized (non-disaggregated) way, which requires powerful hardware at each node.

An object of embodiments herein is to provide a mechanism that improves handling of packets in an efficient manner.

According to an aspect the object may be achieved by providing a method performed by a system for handling one or more packets of an application or a service in a computer environment. The system comprises a first entity and a second entity. The first entity generates a header of a packet and sends the header to the second entity. The second entity adds a payload to the header forming a packet. The second entity then transmits the packet towards a receiver node.

It is furthermore provided herein a computer program product comprising instructions, which, when executed on at least one processor, cause the at least one processor to carry out the methods here, as performed by the respective entity of the system. It is additionally provided herein a computer-readable storage medium, having stored thereon a computer program product comprising instructions which, when executed on at least one processor, cause the at least one processor to carry out the methods herein, as performed by the respective entity of the system.

According to an aspect the object may be achieved by providing a system for handling one or more packets of an application or a service in a computer environment. The system comprises a first entity and a second entity. The system is configured to generate, at the first entity, a header of a packet and to send the header to the second entity. The system is further configured to add, at the second entity, a payload to the header forming a packet, and then to transmit the packet towards a receiver node.

It is herein proposed a disaggregated packet construction solution for, e.g., stateful traffic generators and network testing solutions, using modern programmable network equipment such as smart/programmable NICs, Infrastructure Processing Unit (IPU)/Data Processing Unit (DPU), and programmable (ASIC-based) switches to ensure optimal performance, flexibility, & power-efficiency at a reasonable cost.

Thus, embodiments herein provide a mechanism that handles packets in an efficient manner.

### BRIEF DESCRIPTION OF THE DRAWINGS

Examples of embodiments herein are described in more detail with reference to the attached drawings in which:

FIG. 1 shows a simplified switch architecture with a multi-pipeline data plane according to prior art;

FIG. 2 shows a schematic overview depicting a computer environment according to embodiments herein;

FIG. 3a shows a combined flowchart and signalling scheme according to some embodiments herein;

FIG. 3b shows a combined flowchart and signalling scheme according to some embodiments herein;

FIG. 4 shows a schematic flowchart depicting a method performed by a system according to embodiments herein;

FIG. 5 shows a schematic overview depicting some embodiments herein;

FIG. 6 shows a schematic overview depicting some embodiments herein;

FIG. 7 shows schematic overview depicting a system according to embodiments herein;

FIG. 8 shows an example of a communication system QQ100 in accordance with some embodiments;

FIG. 9 shows a UE QQ200 in accordance with some embodiments;

FIG. 10 shows a network node QQ300 in accordance with some embodiments;

FIG. 11 is a block diagram of a host QQ400, which may be an embodiment of the host QQ116 of FIG. 8, in accordance with various aspects described herein;

FIG. 12 is a block diagram illustrating a virtualization environment QQ500 in which functions implemented by some embodiments may be virtualized; and

FIG. 13 shows a communication diagram of a host QQ602 communicating via a network node QQ604 with a UE QQ606 over a partially wireless connection in accordance with some embodiments.

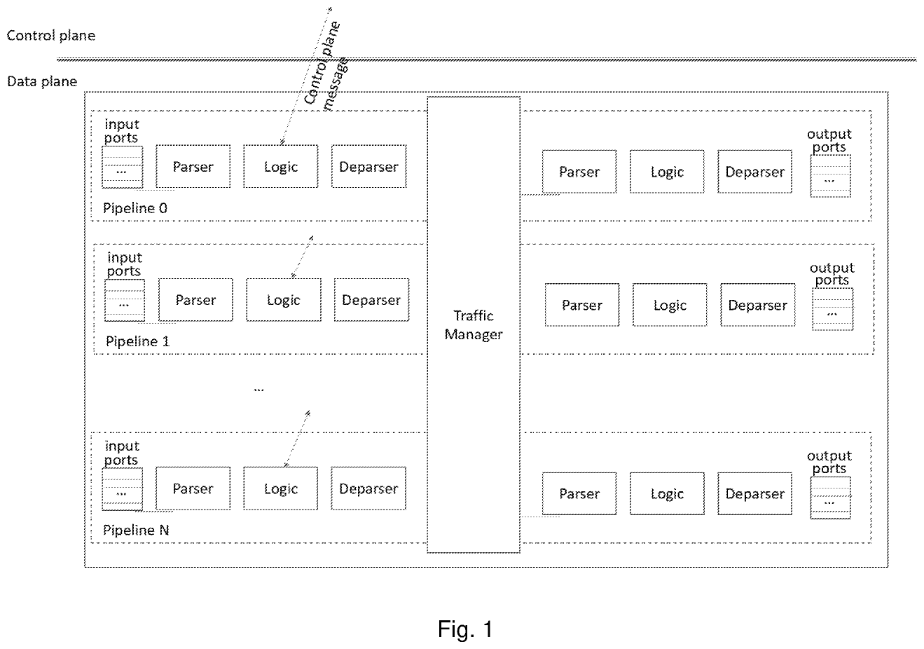

### DETAILED DESCRIPTION

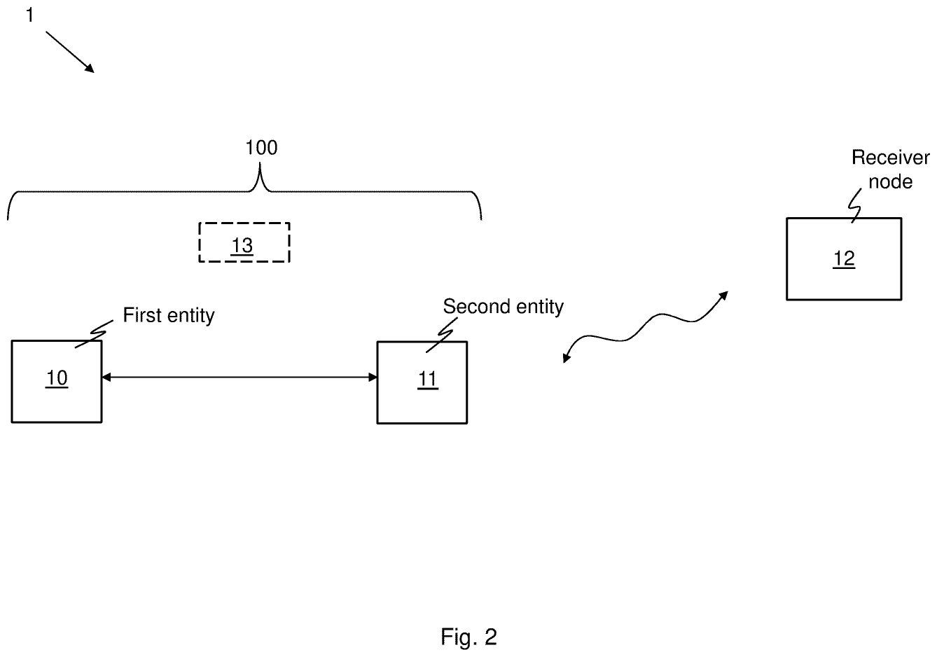

Embodiments herein relate to communication networks in general. FIG. 2 is a schematic overview depicting a computer environment 1. The computer environment 1 may be part of any kind of communication network such as a wired communication network and/or a wireless communication network comprising, e.g., an access network (AN) and a core network (CN). The communication network may comprise logical processing units such as servers or server farms providing compute capacity and may comprise a cloud environment comprising compute capacity in one or more clouds. The communication network may use one or a number of different technologies, such as packet communication, Wi-Fi, Long Term Evolution (LTE), LTE-Advanced, Fifth Generation (5G), NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

In the computer environment 1, a system 100 may handle one or more packets. The system 100 comprises devices or entities, e.g., a first entity 10 such as a processing unit, a computer, a server, or a wireless communication device, that communicate via or within one or more Access Networks (AN), e.g., RAN, and/or one or more core networks (CN).

According to embodiments herein, the system 100 further comprises a second entity 11 for handling packets such as a programmable unit, e.g., a switch, an accelerator, and/or a scheduler.

Furthermore, the computer environment 1 may comprise one or more recipient devices such as a receiver node 12, such as a server, an access node, a user equipment (UE) or a network node comprising one or more functions handling traffic from/to the system 100 and/or within the computer environment 1.

The first and second entities 10, 11 may be standalone entities or collocated entities but logically separated within a computer server. The entities may comprise a network node, a server, a function, a distributed function or similar.

The receiver node 12 may comprise a load balancer, a webserver, a key-value store, a packet scheduler, a radio network node, a scheduler, or similar. The receiver node 12 may provide, e.g., radio coverage over a geographical area, a service area, or a cell, of a radio access technology (RAT), such as NR, LTE, Wi-Fi, WiMAX or similar. The receiver node 12 may thus be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used.

Embodiments herein aim at improving the cost and power efficiency of the software solutions by exploiting the programmability of recent network entities to propose a disaggregated network testing solution that is high-performance, flexible, inexpensive, and power-efficient.

TABLE 1
Different network testing solutions

| Solutions | Flexibility | Cost |
|---|---|---|
| Proprietary | Limited | Very high |
| Hardware | | |
| Programmable | High, but hard to | Reasonable, but gets |
| Hardware (FPGA) | program | higher for higher |
| | | bandwidth |
| Programmable | Reasonable, but | Reasonable up to |
| Hardware (ASIC- | limited. Unable to | terabit-per-second |
| based switches) | perform stateful | rates |
| | network testing and | |
| | gather fine-grained | |
| | statistics | |
| Software | Very high | Reasonable, but |
| | | increases for higher |
| | | bandwidth |

It is herein proposed a system 100 and method for performing disaggregated packet construction in a network with various network entities, such as the first entity 10 and the second entity 11. As opposed to the state-of-the-art solutions that produce the whole packet, e.g., header and payload, on one entity, embodiments herein decouple at least header processing, such as per-flow/packet state management, and payload processing when constructing/deconstructing a packet. By doing so, embodiments herein enable use of available resources more efficiently, thereby improving performance and reducing cost and power consumption. More specifically, embodiments may comprise one or more of the following:
(i) Generate/process packet headers and handles stateful operations, e.g., manage transport protocol states and keep per-flow/per-packet statistics, at the first entity 10 such as CPU-based software and hardware;
(ii) Add a metadata, instead of payload, at the first entity 10, to provide hint for the second entity 11, such as programmable network equipment, responsible for generating the payload; and/or
(iii) Delegate the packet and/or payload generation or construction, and other stateless and/or costly operations, to various entities.

The system 100 may comprise a configurator 13 such as an entity that is responsible for (i) receiving relevant configuration from the user and network administrator and (ii) configuring the relevant entities for performing disaggregated packet construction.

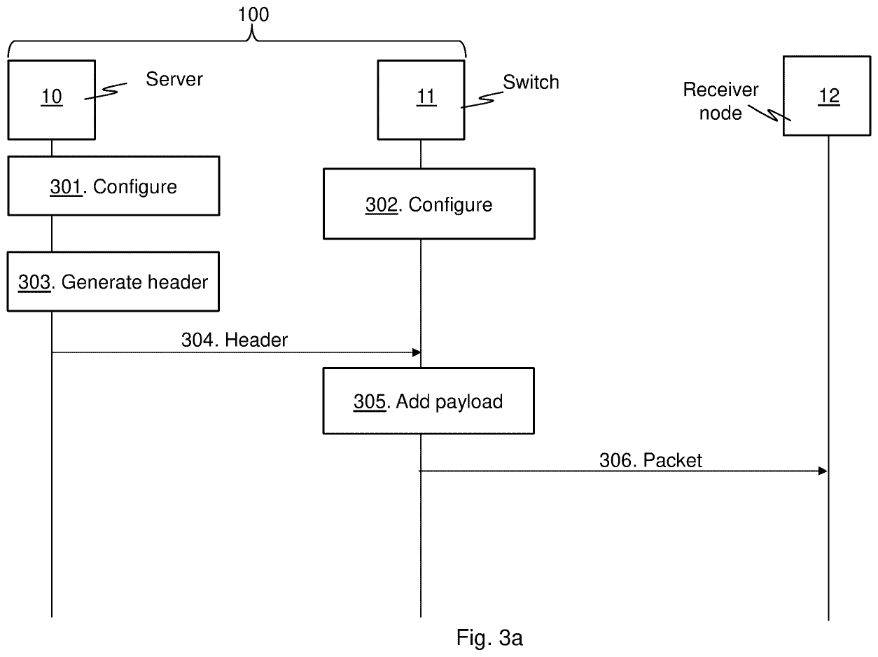

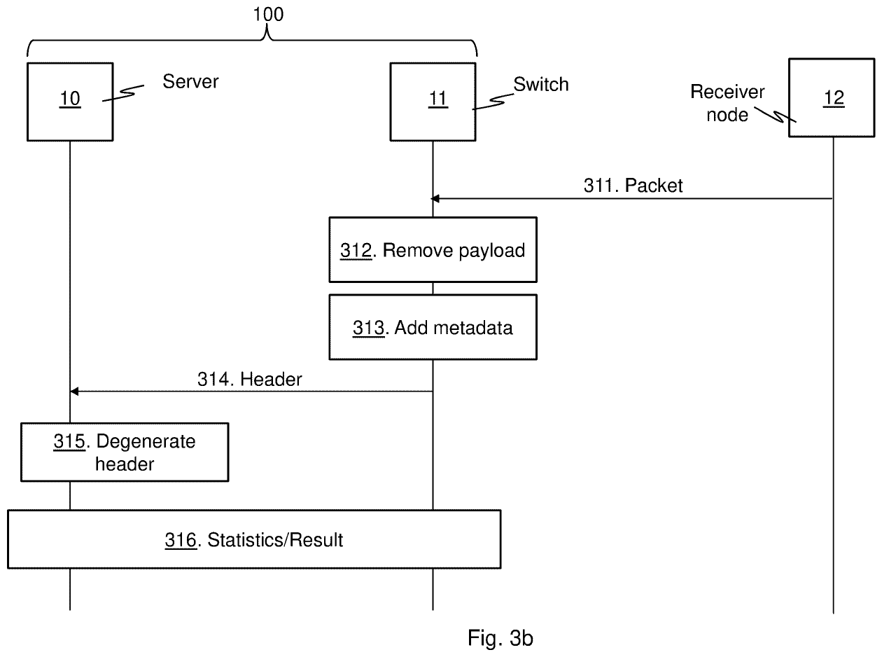

FIG. 3a is a combined flowchart and signalling scheme according to some embodiments herein.

Action 301. The first entity 10, such as a CPU-based server, may be configured from a function or configurator to construct and/or deconstruct a packet according to provided information from the function or configurator.

Action 302. The second entity 11, such as a switch or accelerator, may be configured from the function or the configurator to construct and/or deconstruct the packet according to provided information from the function or configurator.

Action 303. The first entity 10 generates a header of a packet. The first entity 10 may generate a header and then some additional information. For example, the first entity may add metadata such as payload type and/or length.

Action 304. The first entity 10 sends the header to the second entity 11, for example, a header related to a stateful operation such as a TCP header.

Action 305. The second entity 11 adds a payload to the header forming a packet. The second entity 11 may in addition add a checksum to the packet.

Action 306. The second entity 11 transmits the packet towards a receiver node.

Thus, enabling use of available resources more efficiently, thereby improving performance and reducing cost & power consumption.

FIG. 3b is a combined flowchart and signalling scheme according to some embodiments herein.

Action 311. The second entity 11 may further receive from the receiver node 12 or from an intermediate node being between the receiver node 12 and the second entity 11, a second packet related to the transmitted packet. The second packet may be a response, or a packet related to the same service or application as the transmitted packet in action 306.

Action 312. The second entity 11 may remove the payload from the received second packet.

Action 313. The second entity 11 may add metadata to the second header such as one or more response codes to report detailed application status, and/or statistics for the processing of the payload.

Action 314. The second entity 11 may send a second header of the received second packet to the first entity 10.

Action 315. The first entity 10 may then process the second header to obtain information.

Action 316. The first entity 10 may provide statistics and/or result to a user, an administrator, or an operator.

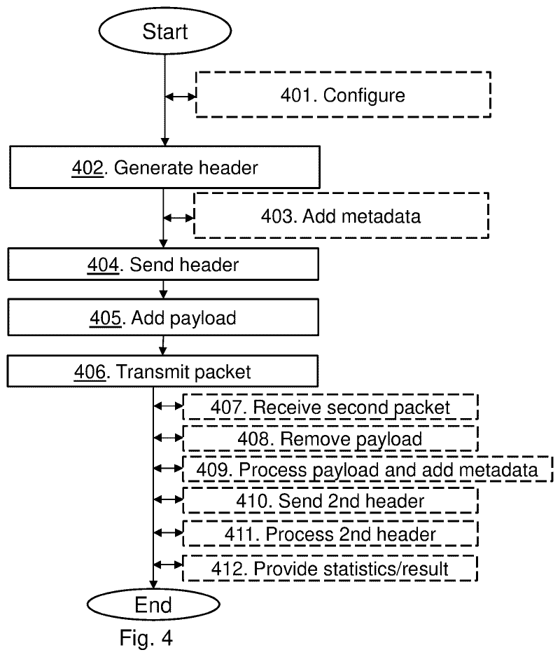

Example embodiments of a method performed by the system 100 for handling one or more packets of an application or a service in a computer environment will now be described with reference to a flowchart depicted in FIG. 4. The actions do not have to be taken in the order stated below, but may be taken in any suitable order. Dashed boxes are optional features. The system 100 comprises the first entity 10 and the second entity 11. The application or service may be related to network testing, database related application, a video related application, a machine learning related application, or a service of data delivery from storage devices. The first entity 10 may be separated from the second entity 11, and the first entity may be a processing unit, such as a CPU-based server and the second entity 11 may be a programmable hardware, such as a programmable switch or accelerator.

Action 401. The system 100 may be configured from an administrator, a configurator or similar to perform methods disclosed herein.

Action 402. The system 100 generates, at the first entity 10, the header of the packet.

Action 403. The system 100 may further add, at the first entity 10, metadata to the header to instruct the second entity to construct the packet. The packet and/or header may be related to a stateful operation. The metadata may comprise a payload length and/or a payload type.

Action 404. The system 100 sends, from the first entity 10, the header to the second entity 11. The first entity may send at least the header and may send additional information such as metadata or other parts of a packet.

Action 405. The system 100 adds, at the second entity 11, the payload to the header forming a packet. The system 100 may further add at the second entity 11, a checksum to the packet. In case the second entity 11 is a NIC with processing capability, e.g., IPU/DPU, the first entity 10, such as a main CPU, may provide some of the information needed in the header to the NIC via PCIe relevant frames, and the NIC adds the remaining information and payload to send the packet. In another example, the second entity 11 may encapsulate a first packet as a payload of another packet, e.g., a telecom packet with proprietary protocol header or a virtual private network (VPN). In such case, the first entity 10 may provide two headers, i.e., a header of the encapsulated packet and a header of the standard/original packet, along with additional information to facilitate the packet construction at the second entity 11. By doing so, the second entity 11 may generate a payload for the first packet, also known as encapsulated packet, and then construct a second packet that uses the first packet as its payload.

Action 406. The system 100 further transmits from the second entity 11, the packet towards the receiver node 12.

Action 407. The system 100 may further receive at the second entity 11, the second packet related to the transmitted packet.

Action 408. The system 100 may remove the payload from the received second packet.

Action 409. The system 100 may perform at the second entity 11, processing on the received payload of the second packet, and attach a result as metadata to the header destined towards the first entity 10. The metadata may comprise one or more response codes to report detailed application status, and/or statistics for the processing of the payload.

Action 410. The system 100 may send the second header of the received second packet from the second entity 11 to the first entity 10.

Action 411. The system 100 may further at the first entity 10, process the second header to obtain information.

Action 412. The system 100 may provide statistics and/or result to a user, an administrator, or an operator.

It is herein proposed a disaggregated architecture to separate state and content management and generation, e.g., by constructing the packet header and payload on different entities.

Embodiments herein provide a system and method for disaggregated packet construction that utilizes available resources more efficiently, and significantly improves performance and power consumption.

Embodiments herein may support stateful network testing at terabits-per-second rates.

It is herein disclosed a disaggregated architecture for generating or constructing packets using commodity hardware, such as CPU-based servers and programmable network equipment such as smart NICs, IPU/DPU, & programable switches.

Embodiments herein may propose a system and method for realizing cost-effective stateful traffic generators and network testers for high-performance networking applications.

Embodiments herein may enable network administrators to benchmark & troubleshoot their TCP-based application at very high rates.

Embodiments herein may offer enough flexibility for network testing at a reasonable cost and power consumption.

Embodiments herein may reduce the number of CPU-based servers required to generate traffic at very high rates.

Embodiments herein may enable disaggregated data centers to deploy networking applications more efficiently by constructing various parts of the packet separately at different locations.

Embodiments herein may improve data delivery to storage devices by disaggregating the packet and payload generation.

Embodiments herein may make it possible to separate state management and machine-learning inference, which can improve throughput & latency significantly.

Described embodiments herein use the disaggregated architecture for network testing and traffic generation. However, it is possible to slightly redefine the system to consider other applications that could benefit from a disaggregated packet construction/generation system to construct the finalized, i.e., ready-to-be-delivered, packet. Three common scenarios that could easily benefit from our proposed solution, are as follows:

Disaggregated data centers: Future-generation data centers are expected to increasingly rely on disaggregated architecture with remote resources & composable hardware, where resources are spread across multiple nodes, e.g., local/memory nodes and various accelerators. The proposed disaggregated packet construction architecture may be used to further benefit from the disaggregated architecture of data centers by extending it to the network. In such an architecture, CPU/compute nodes can prepare/process the packet header(s) and handle stateful operations, and then delegate payload/packet construction/processing to other hardware containing the relevant information, e.g., data available on remote memory nodes or data produced by accelerators, or available/unutilized resources.

Machine-Learning Inference: Online services are increasingly relying on machine learning to generate content. The machine-learning models responsible for generating content are often executed by clusters of graphics processing units (GPU), which may not be physically co-located with the servers running the online services. For instance, a web server that runs on CPU-based commodity hardware does not have enough computational power to execute machine-learning models and generate the content of the packets. Therefore, a webserver has to fetch the content before constructing the packets. Our proposed solution can be used to disaggregate the packet construction by letting the webserver, or the CPU-based server running the online server, prepare the packet header and delegate the payload generation/construction to the hardware running the machine-learning modules, e.g., a CPU-based server prepares the packet header containing TCP fields, and then a remote GPU cluster or an AI-accelerator provides the payload that contains the output of an inference operation Data delivery from storage devices: Non-disaggregated data centers are composed of hierarchical architecture where a client request, for an online service, is typically processed by a server, e.g., a webserver, and later the response is generated on the same server, after fetching the relevant information from a cache or a database. Similar to the Machine-Learning Inference use case, our solution can be used to delegate the construction of the full packet, containing the payload, to the storage devices, e.g., a cache or a database, rather than fetching everything at the server running an online service.

Exemplified embodiments herein focus on the disaggregated & stateful traffic generators and network testers. A skilled person in the field may extend embodiments herein for the network testing and apply it to the other application benefiting from disaggregated packet construction.

Disaggregated and Stateful Traffic Generators and Network Testers Embodiments herein realize disaggregated and stateful traffic generators and network testers on commodity hardware, which simplifies the tester nodes and exploits programmable network equipment to carry out the boilerplate operations. In this example, the aforementioned tasks are performed as follows:
(i) CPU-based software network tester, being an example of the first entity 10, generates/processes packet headers & handles stateful operations, e.g., manage transport protocol states and keep per-flow/per-packet statistics.
(ii) A metadata is attached to the generated packet (header) to inform a programmable network equipment, being an example of the second entity 11, to generate the payload for network testing.
(iii) The programmable network equipment performs the packet/payload generation or construction, and other stateless and/or costly operations, required for networking testing.

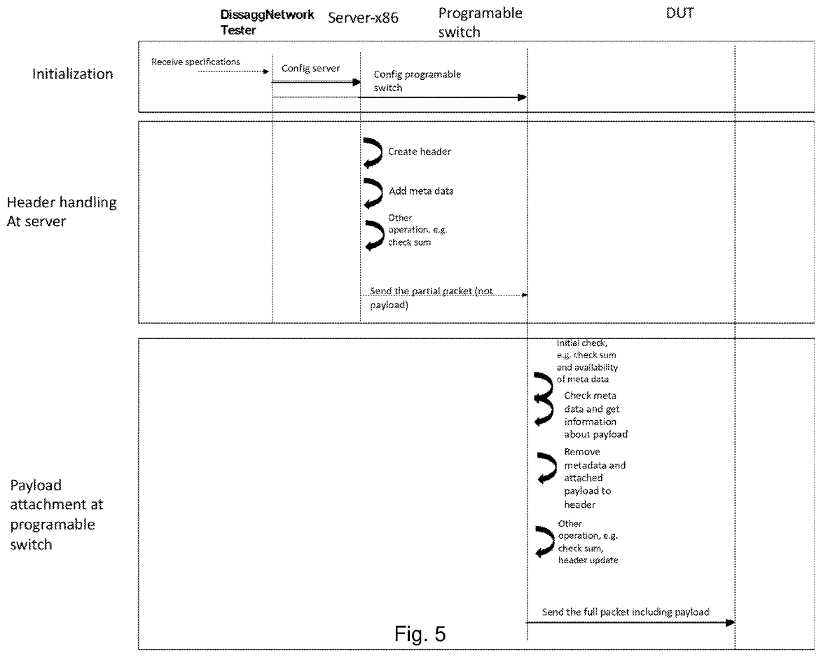

FIG. 5 summarizes the flows of packet generation for the example in network testing.

DissaggNetworkTest architecture may comprise at least a CPU-based server and a programmable network hardware/accelerator. For the sake of presentation, an entity called DissaggNetworkTester may be introduced being an example of the configurator 13, which encapsulates all the required systems and methods for realizing a traffic generator or network tester. DissaggNetworkTester exposes a software API to system administrators, network operators, and developers to define and perform various network tests and to receive test reports, and DissaggNetworkTester handles all the underlying operations seamlessly among different network devices involved in the network testing.

DissaggNetworkTester controlling tasks can be either performed on a separate entity, e.g., another x86 CPU-based server, or as part of the underlying architecture containing CPU-based servers and programmable hardware. During initialization, the DissaggNetworkTester receive specification for configuring the different entities. The DissaggNetworkTester configures the server-x86 and the programmable switch.

At the server-x86 the header of a packet is created. The server-x86 may add some metadata and may further perform some operation such as add a checksum or similar. the server-x86 may then send the header, and some metadata and/or checksum, being an example of a partial packet to the programmable switch.

At the programmable switch, an initial check may be performed such as checking the checksum and/or availability of meta data. The metadata may be checked and information from the metadata may indicate what payload to add. The programmable switch may then remove the metadata and add the payload to the header forming the packet. The programmable switch may then perform some other operation such as add checksum to the packet and may perform an update of the header with additional information. The packet may then be transmitted to or towards a device under test (DUT) or similar.

Embodiments herein enable, for example, a network tester to generate TCP headers at CPU-based servers and delegate the payload generation to a programmable switch. By doing so, the bandwidth between the CPU-based servers and the programmable switch can be utilized more efficiently. In addition, the CPU-servers can operate in a much longer time span, as their output rate can be amplified by the programmable hardware, which consequently reduces the power consumption and costs. In summary, embodiments herein allow construction of a terabit-per-second, flexible, inexpensive, and power-efficient network tester on commodity hardware.

Herein is it described an architecture for a disaggregated network tester and traffic generator. This architecture may be applied to other applications and use cases, such as disaggregated data centers, machine learning inference, and data delivery from/to storage devices.

The DissaggNetworkTester may (i) provide a high-level software interface to network administrators and user to define their network tests & receive test reports and statistics and (ii) seamlessly program & coordinate the underlying hardware to perform the specified tests.

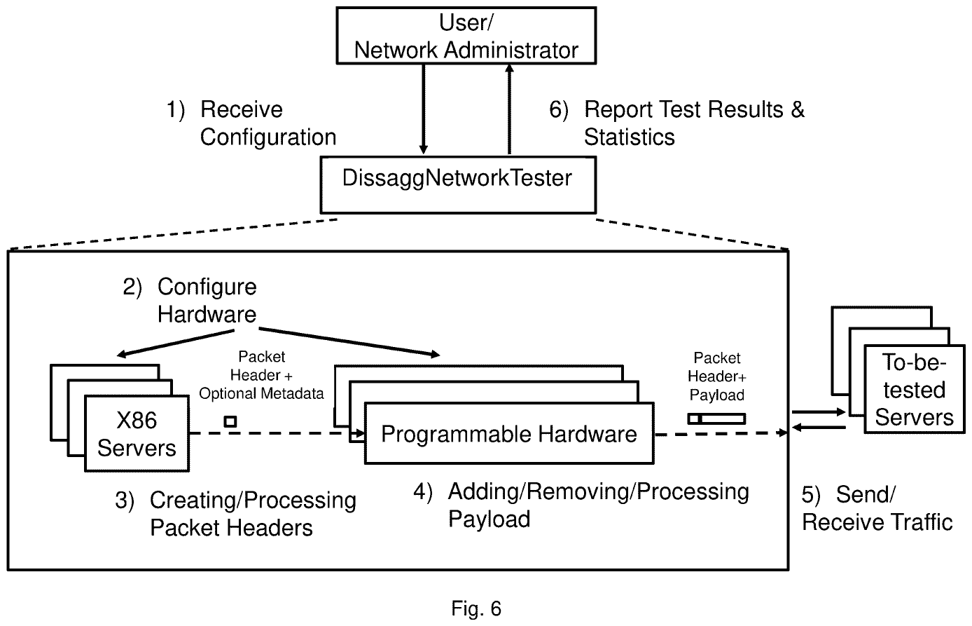

FIG. 6 shows a high-level architecture of DissaggNetworkTester along with different steps/methods required to perform network testing.

It should be noted that packet header and state management may be performed on x86 CPU-based servers; however, this assumption may change in the future. In such a case, this task can be performed in any other suitable network device, hardware, or accelerator. Embodiments herein separate the state management, plus packet header generation, and packet payload construction by introducing a disaggregated network testing architecture.

### High-Level Software Interfaces.

DissaggNetworkTester provides two main high-level software interfaces to the user and network administrator to (i) configuring the testing scenario (Step 1 in FIG. 6) and (ii) receiving the test results and statistics (Step 6 in FIG. 6).
Step 1—Receive configuration. At this step, the user or network administrator provides the necessary configuration to the DissaggNetwork Tester to test a networking application. The configuration can be provided as one or multiple files or it could be passed via multiple function calls. Some information useful for network testing are as follows:
   Underlying hardware details, including the configuration of CPU-based servers, e.g., IP address, number of CPU sockets, number of cores, different NIC interfaces, and programmable hardware, e.g., the required information to access them or supported offloading capabilities.
   Information regarding the test, including the address of end-host, or to-be-tested, servers, the traffic shape or rate to test each server, a list of supported protocols, e.g., UDP, TCP, number of runs/tests, the location & instruction to run the tester software, the payload patterns, e.g., size distribution or payload pattern templates, and any information regarding the packet construction/deconstruction, e.g., where and how to create packet payloads in the transmit path and how to process the packet payloads on the receive path. Step 3 discusses the latter in detail.
   Required statistics and report, including the fundamental network-related metrics, e.g., throughput in packets/bits per second, packet drops, different percentiles for latency and advanced application-related metrics obtained by processing the received payloads from the to-be-tested servers, e.g., the received packets might contain some message or codes that report the status of the to-be-tested servers.
Step 6—Report test results and statistics. At this step, DissaggNetworkTester provides the requested test statistics/results to the user or network administrator. This step can be done passively after finishing the test, e.g., writing the report in a file or sending notification to the user, or on-demand, e.g., via a specific dashboard, interface, or function.

### Low-Level Hardware Details.

DissaggNetworkTester is responsible for (i) configuring the underlying hardware (ii) performing the test based on the provided configuration by the user, and (iii) preparing/gathering the requested statistics from the network.
Step 2—Configuring hardware. At this step, this being an example of action 401, DissaggNetworkTester may configure CPU-based servers and programmable hardware/accelerators to construct and/or deconstruct the packet according to the provided information by the user or network administrator.
   In the Packet Construction (Transmit path), DissaggNetworkTester configures the CPU-based servers to generate packet header and handle the required states, e.g., TCP states, and programs the programmable hardware to generate the rest of the packet, i.e., payload.
   Conversely, in the packet deconstruction (Receive path), DissaggNetworkTester configures the programmable hardware/accelerators to deconstruct the received packets by either removing the whole or part of payload from the received packets or performing a minimal processing on them & attaching the results as an additional payload or metadata. Since the programmable hardware modifies the content of the packet, the testing software running on the CPU-based server should be also configured to expect only packet headers or malformed packets, i.e., it should accept packets regardless of the packet length specified in the packet IP header, or packet header with a minimal payload containing the metadata and results of the payload processing done on the programmable hardware. In cases of a user-space testing software, e.g., DPDK- or netmap-based applications, DissaggNetworkTester does not need to perform any specific modification to the operating system, and the testing software can ensure the correct behavior. However, in case of kernel-based applications, DissaggNetworkTester has to patch the kernel to disable packet or payload verification on the CPU-based servers to ensure the reception of packets by the application. Note that a proper packet verification can be done earlier in the process on the programmable hardware to drop the unverified packets and avoid reporting wrong statistics to the user.
Step 3—Creating and processing packet header, this being examples of action 402,403 and 411. At the transmit path of this step, pre-configured CPU-based servers start generating packet headers based on the pre-determined transport protocol and the destination application servers. The packet header generation may be performed like any header creation process. However, the first entity such as a CPU-based server, may often attach a metadata to the header to instruct the next hop in the network or the programmable network device to generate the rest of the packet, e.g., the packet payload.
   This metadata may comprise payload length or payload type (in cases where payloads are generated in accordance with pre-defined templates).
   At the receive path, the first entity either receives only packet header, without any payload, or the packet header plus a small payload or metadata containing some additional statistics regarding the application metrics obtained by the programmable network device. Below are some examples for the latter alternative.
Step 4—Adding, removing, and processing payload, this being examples of action 405, 408, and 409. In this step, the second entity 11 such as a programmable network device constructs the ready-to-be-transmitted packet and/or may deconstruct the received packet. In the majority of use cases, the programmable network device generates payloads in the transmit path and removes the payload all together in the receive path. However, in some cases the programmable network device may need to perform minimal processing on the received payload and attach the result as a metadata to the packet header destined toward the first entity 10 responsible for generating/processing packet headers. For instance, some applications may include some response codes in the returned packets to report detailed application status, e.g., a Memcached server may return different codes for a GET/SET requests to inform the traffic generator, or clients generating requests, about the status of a key-value pair, e.g., miss or hit. Similarly, a webserver may also report a specific code in case of receiving an unknown HTTP GET request. In these cases, the second entity 11 may extend the packet header with a metadata containing the statistics for the processing of the payloads. The size and content of the metadata depends on the application, and it should be defined in Step 1 during the initialization phase.
Step 5—Send and receive traffic, this being examples of actions 406 and 407. At this step, the generated traffic is sent toward the designated end-host (or to-be-tested) servers, and the processed traffic by the end-host servers are received by the DissaggNetworkTester. Configuring the testbed is beyond the scope of DissaggNetworkTester's responsibilities and we assume that paths between DissaggNetworkTester and end-host servers already exist and are previously configured.

### Implementation Considerations Programmable Switches.

It is herein explained use cases where the payload construction or generation is not dependent on the packet header or application's state. The majority of TCP/UDP-based application typically do not enforce any requirement on the packet generation. For instance, dummy payloads can be generated independently based on a size distribution, or payloads can be generated based on specific pattern or range of values, e.g., payloads can be picked from predefined templates based on a distribution or a pre-defined frequency. One popular example for the latter case could payloads belonging to a key-value stores with a specific application-level protocol, such as Memcached, where different fields, e.g., operation type SET/GET or key/value pairs, can be generated based on a pre-defined information. However, some applications may introduce dependencies between the packet header and payload. For example, generating encrypted payloads may require knowing some state or the exchanged certificate between the testers and the end-host servers. Therefore, different entities involved in network testing, e.g., the programmable hardware and the CPU-based server, may communicate and exchange some information with each other during the testing process. For the sake of simplicity, we do not elaborate this use case, but we believe this alternative extension can be easily extracted by an expert in the field, as some works in the literature have already shown the autonomous transport layer security (TLS), and other layer-5 protocol, offloads into smart NICs. Similarly, DissaggNetworkTester can use similar techniques to generate dependent packet payloads using smart NICs and programmable switches.

Focusing on programmable ASIC switches as the second entity 11, DissaggNetworkTester could be realized by generating headers on a CPU-based server and appending payloads using a programmable switch. A switch may support the extension of a packet with a dummy payload, e.g., extending a packet with a certain amount of 0x00 octets. When a switch does not support extending a packet with dummy bits, the switch may multicast and recirculate templates of payloads, generated with an external traffic generator, and then append such payloads to the headers generated by the CPU-based server. One way to attach the payloads to the headers may be to store the incoming headers on an SRAM memory on the switch and then append the headers to the payloads when a payload is processed at the switch. It is beneficial to store headers instead of payloads because headers are smaller than payloads and memory on the switch is a renowned constrained resource. When packets are received from the device under test on the switch, the switch may generate a metadata with compressed information similarly to the aforementioned description.

### Execution of an Example.

The details of the DissaggNetworkTester may be described by executing an example in three main stages: initialization, testing, and reporting.

In this example, the system 100 uses an x86 CPU-based SERVER and a programmable switch, and it is testing a web server via a known HTTP benchmarking tool, e.g., wrk, that is customized for a disaggregated architecture. Additionally, the DissaggNetworkTester may be co-located on the same CPU-based server that runs the tests. The x86 CPU-based server may perform the TCP-related state management and creates/processes packet headers and the multi-pipeline programmable switch generates/removes packet payloads and/or metadata before sending the finalized packets toward the web server(s). In this example, the switch may recirculate and multicast packets from an external payload generator.

### Initialization:

During the initialization phase, the user or network administrator provides the necessary configuration & information to the DissaggNetworkTester (according to Step 1 in FIG. 6).

The user may provide the following information:
The configuration of the CPU-based server and the programmable switch to do the test. This information contains the IP addresses of relevant interfaces on the underlying hardware to program and configure them according to the provided information, e.g., via ssh.

### Testing:

After the initialization phase, DissaggNetworkTester starts performing the test based on the given duration or the number of runs. For the sake of simplicity, details of one test and one TCP connection are disclosed, where the connection is established, packets are generated and processed by the underlying hardware controlled by the DissaggNetworkTester, and finally the connection is closed.
The CPU-based server establishes a TCP connection between the generator and the web server.

The programmable switch may not need to generate any specific payload during this step as TCP handshake messages are small sized.
After the connection is established, the CPU-based server starts performing the test.

What is generated in the header by the CPU-based server? The CPU based server may run a modified TCP networking stack, e.g., a user-space variant, and wrk client where the payloads of the wrk client are replaced with smaller metadata fields that are appended as additional headers after the TCP headers. As an example, a GET HTTP request for a specific file may be encoded in a 16-bit header field where the msb is ‘0’ for representing a GET request, and ‘1’ for a POST, and the remaining 15 bits identifies a specific file that needs to be fetched on the server under test. The header is sent to the programmable switch.

What is generated in the payload by the switch? For instance, the segmentation may be performed here, similar to TCP segmentation offload (TSO) for TX and de-TSO, or Large Receive Offload (LRO), for RX by removing the payloads and concatenating the headers.

The programmable switch stores every header that it receives into its fast SRAM memory. At the same time, the programmable switch receives template payload-based packets of HTTP GET requests from an external device. These template packets also contain a cyclic redundancy check (CRC) of the payload that will be needed to compute the final TCP checksum. When a template payload-based packet arrives at the switch, the following operations are performed:
The switch checks whether there is a header stored in memory;
If this is the case, the switch checks the type of HTTP request. If it is a GET request, it extracts the file-identifier from the metadata of the header and it replaces the correct URL in the template payload. It then prepends the payload with the TCP header stored in memory.
The switch updates the TCP checksum based on the CRC stored in the template payload-based packet and the CRC of the file URLs that are pre-stored on memory on the switch for all the files, these can also be appended as metadata by the CPU-based server.
The switch sends the packet to the server under the test.
What is returned by the web server?
The web server processes the received packet which now consists of a header and an HTTP payload. The webserver will generate an HTTP response, i.e., a packet related to the received packet, that will be transmitted back to the sender using on top of TCP. For a file whose size does not fit one packet, the response may span across multiple TCP messages.

What is processed/removed on the switch being an example of the second entity 11?

The programmable switch may perform the following operations:
The programmable switch may determine from the first packets received by the web server whether the HTTP GET has been successfully handled or not. The programmable switch may remove the payload and add a metadata field that encodes the HTTP state of the GET request, e.g., success, and/or error type. The packet is forwarded to the CPU-based traffic generator server.
What is done by the CPU-based server being an example of the first entity 10?

The CPU-based server may run a modified TCP networking stack and wrk client that has been adapted to receive TCP messages that do not contain the full payload but rather an encoding of the application status. The TCP networking stack will generate the proper ACK messages that will be sent back to the user. In the case the generator server receives an error HTTP response, the wrk client will run an additional pre-configured HTTP logic, and potentially generate a new GET request.

The last step may be performed many times for many different connections, based on the number of connections, the test duration, and the configuration provided by the user.

Finally, the CPU-based server closes the TCP connection and ends the test by gathering the statistics provided by the testing software.

### Reporting:

After finishing the DissaggNetworkTester may retrieve the statistics from the testing software and may write the result into a file at the provided path by the user.

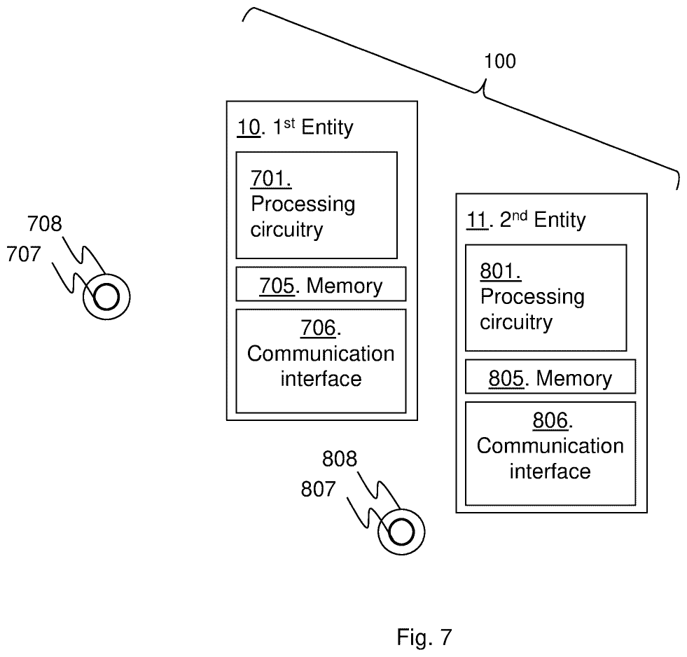

FIG. 7 depicts in a block diagram manner the system for handling one or more packets of an application or service in a computer environment according to embodiments herein. The system comprises the first entity 10 and the second entity 11.

The system is configured to generate, at the first entity 10, the header of the packet. The system is configured to send, from the first entity 10, the header to the second entity 11. The system 100 is configured to add, at the second entity 11, the payload to the header forming the packet; and to transmit, from the second entity 11, the packet towards the receiver node 12.

The packet and/or header may be related to a stateful operation.

The system 100 may further be configured to add, at the first entity 10, the metadata to the header to instruct the second entity to construct the packet.

The metadata may comprise the payload length and/or the payload type. The system may further be configured to add the payload by further adding, at the second entity 11, a checksum to the packet.

The system 100 may be configured to receive at the second entity 11, the second packet related to the transmitted packet. The system 100 may further be configured to remove the payload from the received second packet, and to send the second header of the received second packet from the second entity 11 to the first entity 10. The system 100 may further be configured to process, at the first entity, the second header to obtain information.

The system 100 may further be configured to perform, at the second entity 11, the processing on the received payload and to attach the result as metadata to the header destined towards the first entity 10.

The metadata may comprise one or more response codes to report detailed application status, and/or statistics for the processing of the payload.

The system 100 may further be configured to provide statistics and/or result to a user, an administrator, or an operator.

The application or service may be related to network testing, database related application, a video related application, a machine learning related application, or a service of data delivery from storage devices.

The first entity 10 may be separated from the second entity 11, and the first entity 10 may be a processing unit and the second entity 11 may be a programmable hardware.

The respective entity may comprise a respective processing circuitry 701, 801, e.g., one or more processors, configured to perform the methods herein, respectively.

The respective entity may comprise a respective memory 705, 805. The respective memory comprises one or more units to be used to store data on, such as data packets, headers, payload, metadata, processing time, configurations, measured parameters, data storage, data structures, hash table, transient data structure, transient states table, indications, events and applications to perform the methods disclosed herein when being executed, and similar. Furthermore, the respective entity may comprise a respective communication interface 706, 806 such as comprising a transmitter, a receiver, a transceiver and/or one or more antennas.

The methods according to the embodiments described herein for the respective entity are respectively implemented by means of e.g., a respective computer program product 707, 807 or a computer program, comprising instructions, i.e., software code portions, which, when executed on at least one processor, cause the at least one processor to carry out the actions described herein, as performed by the respective entity of the system 100. The respective computer program product 707,807 may be stored on a computer-readable storage medium 708, 808, e.g., a disc, a universal serial bus (USB) stick or similar. The computer-readable storage medium 708,808, having stored thereon the computer program product, may comprise the instructions which, when executed on at least one processor, cause the at least one processor to carry out the actions described herein, as performed by the respective entity of the system 100. In some embodiments, the computer-readable storage medium may be a transitory or a non-transitory computer-readable storage medium. Thus, embodiments herein may disclose a system for handling one or more packets of an application or service in a computer environment, wherein the system comprises processing circuitry and a memory, said memory comprising instructions executable by said processing circuitry whereby said system is operative to perform any of the methods herein.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

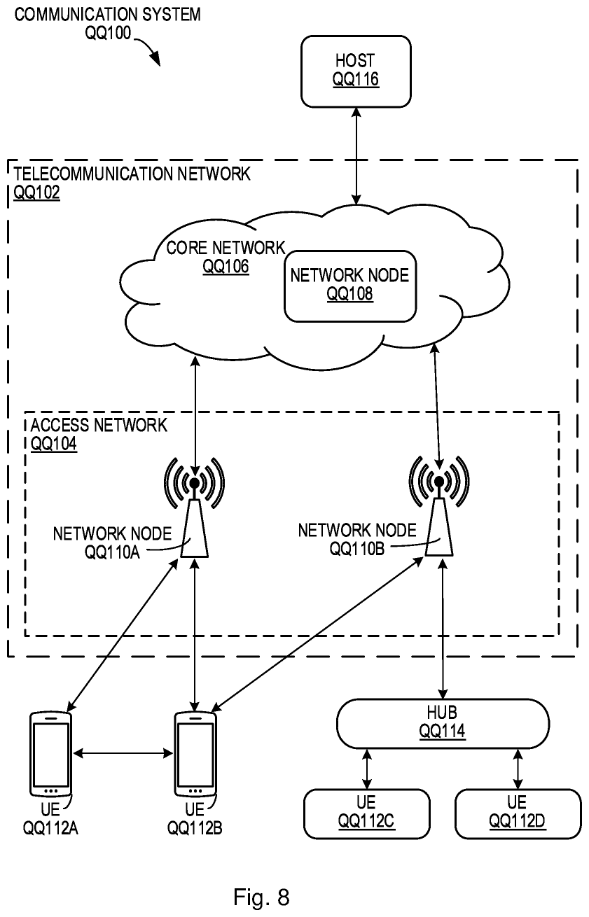

FIG. 8 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access nodes or non-3GPP access points. Moreover, as will be appreciated by those of skill in the art, a network node, being examples of the entities herein, is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

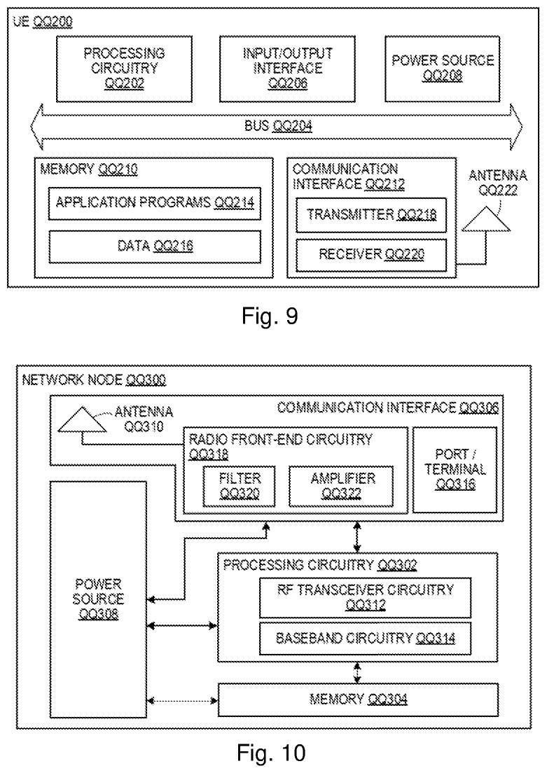

FIG. 9 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

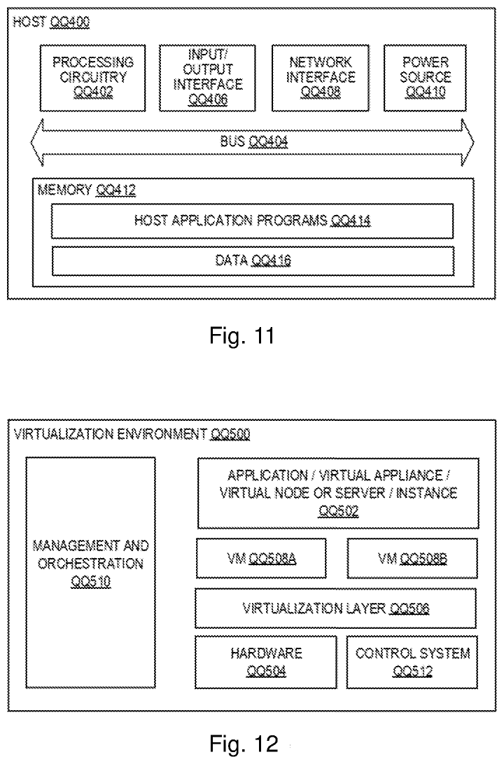

FIG. 11 is a block diagram of a host QQ400, which may be an embodiment of the host QQ116 of FIG. 8, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 9 and 10, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

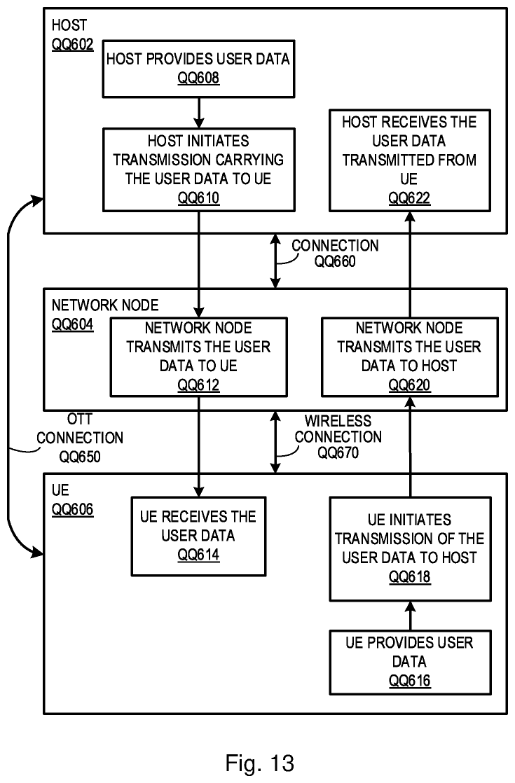

FIG. 13 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 8 and/or UE QQ200 of FIG. 9), network node (such as network node QQ110a of FIG. 8 and/or network node QQ300 of FIG. 10), and host (such as host QQ116 of FIG. 8 and/or host QQ400 of FIG. 11) discussed in the preceding paragraphs will now be described with reference to FIG. 13.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 8) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the latency and packet handling and thereby provide benefits such as reduced user waiting time, better responsiveness or similar.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a system for handling one or more packets of an application or a service in a computer environment, wherein the system comprises a first entity and a second entity, the method comprising:
generating, at the first entity, a header of a packet;
sending, from the first entity, the header to the second entity;
adding, at the second entity, a payload to the header forming a packet; and
transmitting, from the second entity, the packet towards a receiver node.

2. The method according to claim 1, wherein the packet and/or header is related to a stateful operation.

3. The method according to claim 1, further comprising
adding, at the first entity, metadata to the header to instruct the second entity to construct the packet.

4. The method according to claim 3, wherein the metadata comprises a payload length and/or a payload type.

5. The method according to claim 1, wherein adding the payload further comprises adding, at the second entity, a checksum to the packet.

6. The method according to claim 1, further comprising
receiving at the second entity, a second packet related to the transmitted packet;
removing the payload from the received second packet;
sending a second header of the received second packet from the second entity to the first entity;
processing, at the first entity, the second header to obtain information.

7. The method according to claim 6, further comprising
performing, at the second entity, processing on the received payload, and attaching a result as metadata to the header destined towards the first entity.

8. The method according to claim 7, wherein the metadata comprises one or more response codes to report detailed application status, and/or statistics for the processing of the payload.

9. The method according to claim 6, further comprising providing statistics and/or result to a user, an administrator, or an operator.

10. The method according to claim 1, wherein the application or service is related to network testing, database related application, a video related application, a machine learning related application, or a service of data delivery from storage devices.

11. The method according to claim 1, wherein the first entity is separated from the second entity, and the first entity is a processing unit and the second entity is a programmable hardware.

12. (canceled)

13. A computer-readable storage medium, having stored thereon a computer program product comprising instructions which, when executed on at least one processor, cause the at least one processor to carry out the method according to claim 1.

14. A system for handling one or more packets of an application or service in a computer environment, wherein the system comprises a first entity and a second entity, wherein the system is configured to:
generate, at the first entity, a header of a packet;
send, from the first entity, the header to the second entity;
add, at the second entity, a payload to the header forming a packet; and
transmit, from the second entity, the packet towards a receiver node.

15. The system according to claim 14, wherein the packet and/or header is related to a stateful operation.

16. The system according to claim 14, wherein the system is configured to:
add, at the first entity, metadata to the header to instruct the second entity to construct the packet.

17. The system according to claim 16, wherein the metadata comprises a payload length and/or a payload type.

18. The system according to claim 14, wherein the system is configured to add the payload by further adding, at the second entity, a checksum to the packet.

19. The system according to claim 14, wherein the system is configured to:
receive at the second entity, a second packet related to the transmitted packet;
remove the payload from the received second packet;
send a second header of the received second packet from the second entity to the first entity; and
process, at the first entity, the second header to obtain information.

20. The system according to claim 19, wherein the system is configured to perform, at the second entity, processing on the received payload and attach a result as metadata to the header destined towards the first entity.

21. The system according to claim 20, wherein the metadata comprises one or more response codes to report detailed application status, and/or statistics for the processing of the payload.

22-24. (canceled)
